(19) United States
(12) Patent Application Publication
(10) Pub. No.: US 2014/0012165 A1
(43) Pub. Date: Jan. 9, 2014

(54) System of a Magnetic Attachment Handle and Attachment devices

(71) Applicant: Thomas D. COCKLEY, Elkins Park, PA (US)

(72) Inventor: Thomas D. COCKLEY, Elkins Park, PA (US)

(21) Appl. No.: 13/934,691

(22) Filed: Jul. 3, 2013

Related U.S. Application Data
(60) Provisional application No. 61/668,514, filed on Jul. 6, 2012.

(51) Int. Cl. B25G 3/02; A46B 17/02; G02B 7/18; G02B 7/14; F21V 21/096; A61H 5/00; G02B 7/00

(52) U.S. Cl. CPC B25G 3/02; A61H 5/00; A46B 17/02; G02B 7/006; G02B 7/14; F21V 21/0965; G02B 7/1805
USPC 601/37; 16/422; 15/143.1; 359/888; 359/811; 362/249.01; 359/831

(57) ABSTRACT

A system of a magnetic attachment handle and attachment devices includes an attachment handle and a plurality of devices. Each of plurality of devices includes a device magnet which attaches with a handle magnet of the attachment handle so that the attachment handle can be interchangeably attached with a chosen device from the plurality of devices. The chosen device that attaches with the attachment handle is selected by a user as the plurality of devices can be different from one another.

The current application claims a priority to the U.S. Provisional Patent application Ser. No. 61/668,514 filed on Jul. 6, 2012.

### FIELD OF THE INVENTION

The present invention generally relates to an apparatus for a handle, more specifically, the present invention is an apparatus for a handle that utilizes magnetic attachment. The present invention allows a user to easily attach or detach a handle onto a device by utilizing magnetic attachment.

### BACKGROUND OF THE INVENTION

When using a device with permanent handles, the device can become difficult to transport because the permanent handle is cumbersome. Devices with permanent handles are difficult to move because these devices are large and bulky. Once the devices with the permanent handles are in a preferred area, it is difficult for a user to move the devices from one spot to another spot within the area. Examples of current products on the market include, but are not limited to: conventional prism devices such as stick prisms, magnifiers, illuminated devices, brushes, and canes. More specifically, stick prisms can be difficult to transport due to the size of the stick in comparison to the prism itself because they are large and bulky.

It is therefore an object of the present to invention to provide a handle, which is easy to attach and detach to a plurality of devices by utilizing a magnetic attachment. In order to magnetically attach the handle, a chosen device is selected from the plurality of devices by a user, where each of the plurality of devices comprises different functionality.

### BRIEF DESCRIPTION OF THE DRAWINGS

FIG. 1 is a perspective view of the first alternative embodiment of the present invention.

FIG. 2 is an exploded view of the first alternative embodiment of the present invention.

FIG. 3 is a perspective view of the second alternative embodiment of the present invention.

FIG. 4 is an exploded view of the second alternative embodiment of the present invention.

FIG. 5 is a perspective view of the third alternative embodiment of the present invention.

FIG. 6 is an exploded view of the third alternative embodiment of the present invention.

FIG. 7 is a perspective view of the fourth alternative embodiment of the present invention.

FIG. 8 is an exploded view of the fourth alternative embodiment of the present invention.

FIG. 9 is a perspective view of the fifth alternative embodiment of the present invention.

FIG. 10 is an exploded view of the fifth alternative embodiment of the present invention.

FIG. 11 is a perspective view of the sixth alternative embodiment of the present invention.

FIG. 12 is an exploded view of the sixth alternative embodiment of the present invention.

### DETAIL DESCRIPTIONS OF THE INVENTION

All illustrations of the drawings are for the purpose of describing selected versions of the present invention and are not intended to limit the scope of the present invention.

The present invention is a system, which allows a user to easily attach and detach a holding portion onto a device by utilizing a magnetic attachment. The present invention comprises an attachment handle 1 and a plurality of devices 6. The attachment handle 1 is magnetically attached with a chosen device from the plurality of devices 6, where the chosen device is selected by the user.

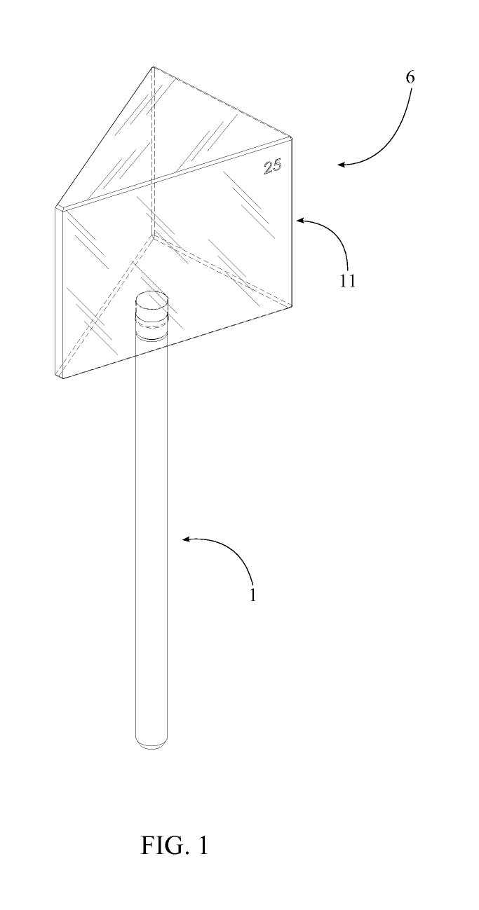

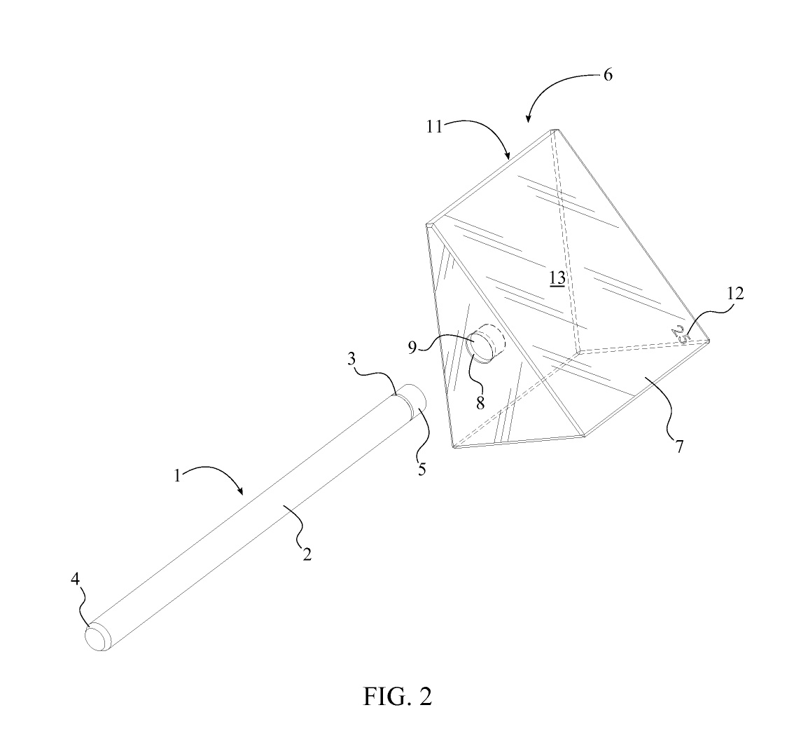

In reference to FIG. 1 and FIG. 2, the attachment handle 1 comprises a handle body 2, a first end 3, a second end 4, and a handle magnet 5. The first end 3 and the second end 4 are oppositely positioned from each other along the handle body 2. The handle body 2 preferably comprises a circular shaped body for ergonomic positioning so that the user can comfortably grip or hold the handle body 2. The handle body 2 is made from high-strength and lightweight material that includes, but is not limited to: wood, glass, plastic, metal, ceramic, and biocomposite materials. The handle magnet 5 is adjacently connected with the first end 3, where the handle magnet 5 is concentrically positioned with the handle body 2. The second end 4 functions as a free end within the present invention so that the user can easily indentify the first end 3 apart from the second end 4. The handle magnet 5 is a permanent magnet which is able to magnetically attach with oppositely attractive magnets or surfaces. The handle magnet 5 is preferably shaped into the same shape as the handle body 2 so that both the handle body 2 and the handle magnet 5 have a continuous flow throughout the attachment handle 1.

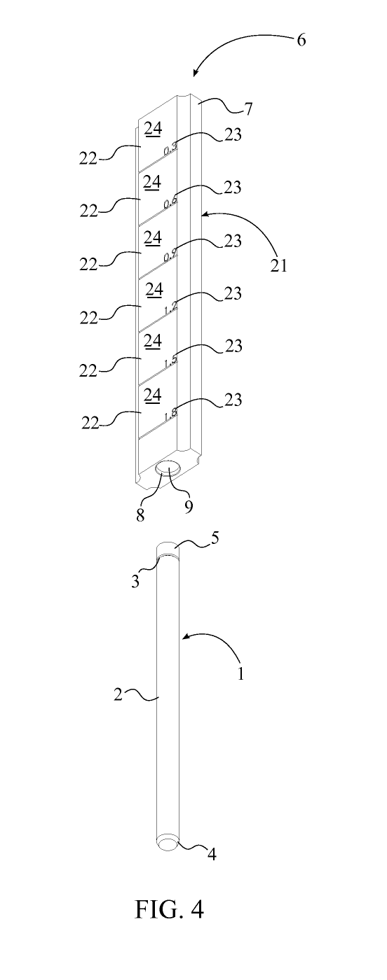

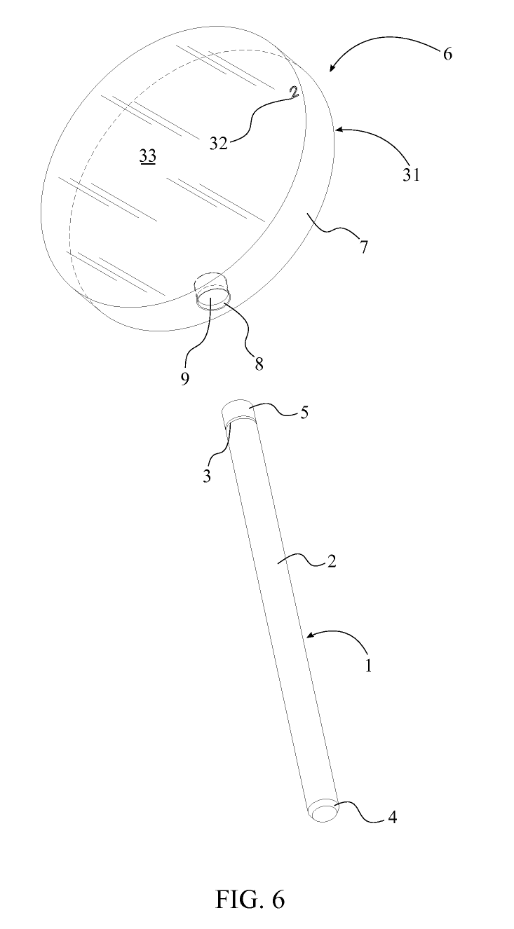

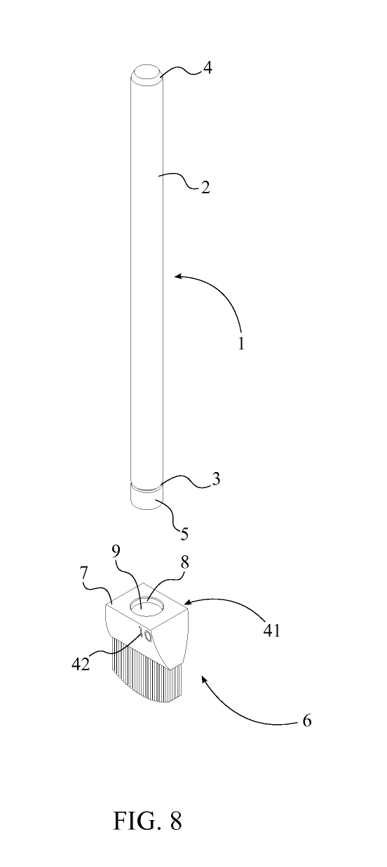

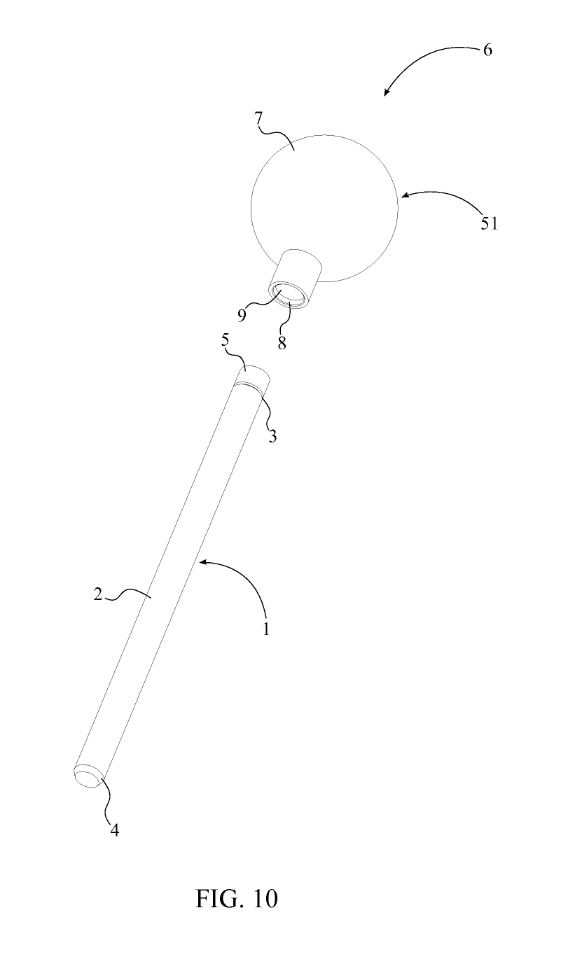

In reference to FIG. 2, FIG. 4, FIG. 6, FIG. 8, and FIG. 10, each of the plurality of devices 6 comprises a device body 7, a cavity 8, and a device magnet 9. The cavity 8 is traversed into the device body 7, where the cavity 8 houses the device magnet 9. More specifically, the cavity 8 is preferably shaped into the same shape as the attachment handle 1, and the device magnet 9 is concentrically connected within the cavity 8. The device magnet 9 is preferably shaped and into the same shape as the cavity 8 and the handle magnet 5 so that the device magnet 9 can concentrically connect with the handle magnet 5 with a zero offset as the attachment handle 1 concentrically positions with the cavity 8. When the chosen device is magnetically attached with the attachment handle 1 due to the opposite attraction of the handle magnet 5 and the device magnet 9, the present invention can be properly used by the user as the attachment handle 1 provides a holding surface while allowing the chosen device to function without any interference from the user.

Even though the handle magnet 5 attaches with the device magnet 9 in the present invention, in an alternative embodiment of the present invention, the handle magnet 5 can be attached with an oppositely attractive magnetic surface. More specifically, the oppositely attractive magnetic surface is positioned at the bottom of the cavity 8 so that the handle magnet 5 can be magnetically attached with the oppositely attractive magnetic surface through the cavity 8.

Since the attachment handle 1 is interchangeably attached with each of the plurality of devices 6 and the plurality of devices 6 only requires one attachment handle 1, the present invention is more portable and exceedingly easy to transport and store in comparison to devices with permanent handle. Due to the single attachment handle 1, the present invention also more lightweight as a system in comparison to the devices with permanent handle. The magnetic attachment, which attaches the attachment handle 1 with the plurality of devices 6, also provides a seamless exchange between the attachment handle 1 and the plurality of devices 6 when the attachment handle 1 is interchanged within the plurality of devices 6. Both the handle magnet 5 and the device magnet 9 are sufficiently magnetized within the present invention in order to eliminate unexpected separation and rotation of the attachment handle 1 with respect to the chosen device.

In reference to FIG. 1 and FIG. 2, a first alternative embodiment of the present invention, the plurality of devices 6 is a plurality of orthoptics treatment prisms 11. The plurality of orthoptics treatment prisms 11 is normally used in the medical field, where the plurality of orthoptics treatment prisms 11 functions as optical exerciser for treating or exercising the muscles of the eye thereby to correct misalignment of the eye that is commonly known as cross eyedness or strabismus. Each of the plurality of orthoptics treatment prisms 11 comprises a diopter identification number 12, where the diopter identification number 12 is positioned on the device body 7. More specifically, the diopter identification number 12 is positioned on a prism viewing surface 13 of each of the plurality of orthoptics treatment prisms 11 instead of a side surface, where it would have been traditionally placed. The prism viewing surface 13 is positioned on the device body 7 and normally faces toward the practitioner when the first alternative embodiment is used by the practitioner. This enhancement makes the plurality of orthoptics treatment prisms 11 much better, easier, and quicker for the practitioner since the practitioner no longer has to move his/her eyes from the prism viewing surface 13 to the side surface to get the diopter identification number 11 The placement of the diopter identification number 12 on the prism viewing surface 13 also results in more accurate readings. Due to the fact that there is the possibility of losing its place within the respective orthoptics treatment prism 11 and recording the incorrect diopter identification number 12. Since the plurality of devices 6 of the first alternative embodiment is the plurality of orthoptics treatment prisms 11, the chosen device of the first alternative embodiment is a single orthoptics treatment prism 11 from the plurality of orthoptics treatment prisms 11.

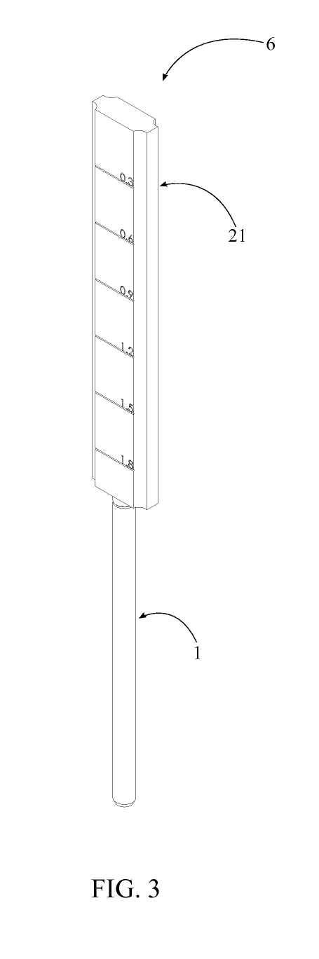

In reference to FIG. 3 and FIG. 4, a second alternative embodiment of the present invention, the plurality of devices 6 is a plurality of neutral density bars 21. The plurality of neutral density bars 21 is normally used in the medical field, where the plurality of neutral density bars 21 is used conjunction with a swinging flashlight to detect the depth of any afferent conduction defect. Each of the plurality of neutral density bars 21 comprises a plurality of filters 22 that linearly connects to each other within the device body 7, where the plurality of filters 22 completes the device body 7 of the second alternative embodiment. Each of the plurality of filters 22 comprises a respective optical density value 23, where the respective optical density value 23 is positioned on each of the plurality of filters 22. Similar to the first alternative embodiment, the respective optical density value 23 is positioned on a density bar viewing surface 24 of each of the plurality of filters 22, and all of the density bar viewing surfaces 24 are positioned on the device body 7 and face the practitioner when the second alternative embodiment is used by the practitioner. This enhancement makes the plurality of neutral density bars 21 much better, easier, and quicker for the practitioner so that the practitioner no longer has to move his/her eyes from the density bar viewing surface 24 to the side surface to get the respective optical density value 23. The placement of the respective optical density value 23 on the density bar viewing surface 24 also results in more accurate readings since there is the possibility of losing its place within the plurality of filters 22 and recording the incorrect the respective optical density value 23. Since the plurality of devices 6 of the second alternative embodiment is the plurality of neutral density bars 21, the chosen device of the second alternative embodiment is a single neutral density bar 21 from the plurality of neutral density bars 21.

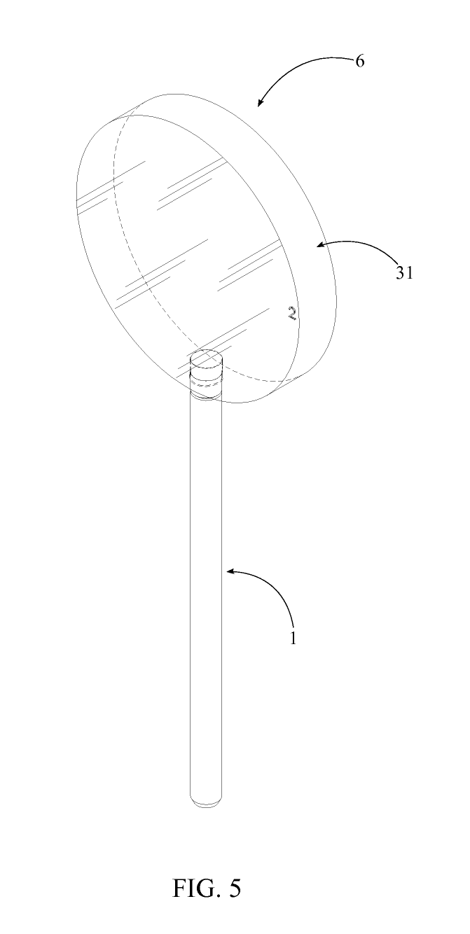

In reference to FIG. 5 and FIG. 6, a third alternative embodiment of the present invention, the plurality of devices 6 is a plurality of magnifiers 31. Each of the plurality of magnifiers 31 comprises a respective magnifying number 32, where the respective magnifying number 32 is positioned on the device body 7. Similar to the first and second alternative embodiment, the respective magnifying number 32 is positioned on a magnifier viewing surface 33 of each of the plurality of magnifiers 31, where the magnifier viewing surface 33 is positioned on the device body 7 of the third alternative embodiment. Since the plurality of devices 6 of the third alternative embodiment is the plurality of magnifiers 31, the chosen device of the third alternative embodiment is a single magnifier 31 from the plurality of magnifiers 31.

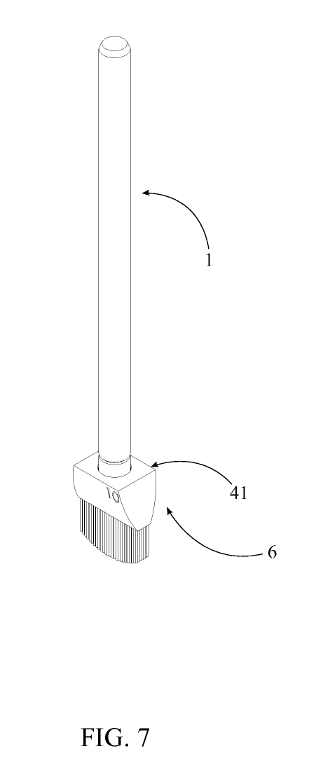

In reference to FIG. 7 and FIG. 8, a fourth alternative embodiment of the present invention, the plurality of devices 6 is a plurality of brush heads 41 where the plurality of brush heads 41 can include, but is not limited to: tooth brush heads, paint brush heads, and broom heads. Each of the plurality of brush heads 41 comprises a respective brush size number 42, where the respective brush size number 42 is positioned on the device body 7 for identification purpose. For example, the brush size number 10 of a paint brush can represent a width of 7/32 of inches while the brush size number 12 of a paint brush represent a width of 9/32 of inches. Since the plurality of devices 6 of the fourth alternative embodiment is the plurality of brush heads 41, the chosen device of the fourth alternative embodiment is a single brush head 41 from the plurality of brush heads 41.

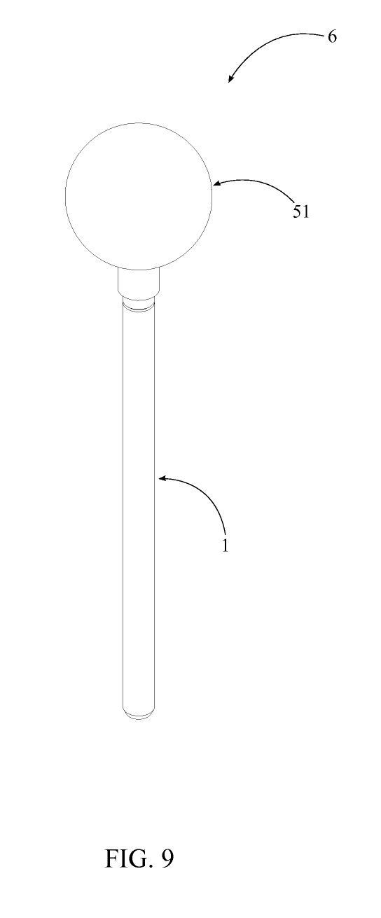

In reference to FIG. 9 and FIG. 10, a fifth alternative embodiment of the present invention, the plurality of devices 6 is a plurality of illumination devices 51 where the plurality of illumination devices 51 can include, but is not limited to: lights and lighting devices. Each of the plurality of illumination devices 51 comprises a respective identification number, where the respective identification number is positioned on the device body 7 and differentiates each of the plurality of illumination devices 51 from one another. For example, the respective identification numbers of two electric blubs can be 25 watts and 45 watts, where the 25 watts and 45 watts represent the electrical power consumed by the two electric blubs. Since the plurality of devices 6 of the fifth alternative embodiment is the plurality of illumination devices 51, the chosen device of the fifth alternative embodiment is a single illumination device 51 from the plurality of illumination devices 51.

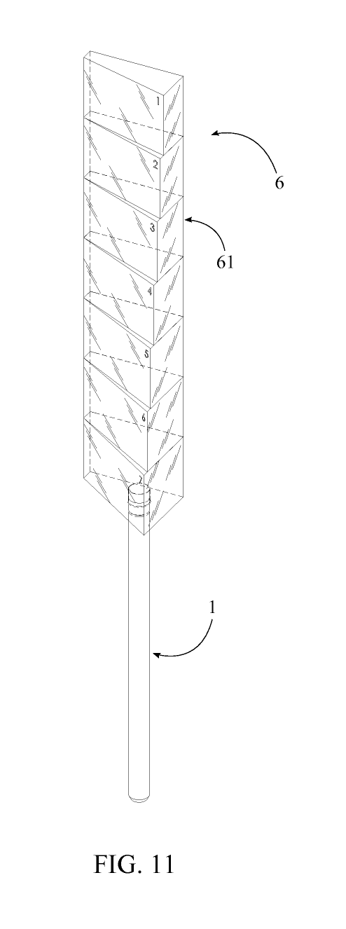

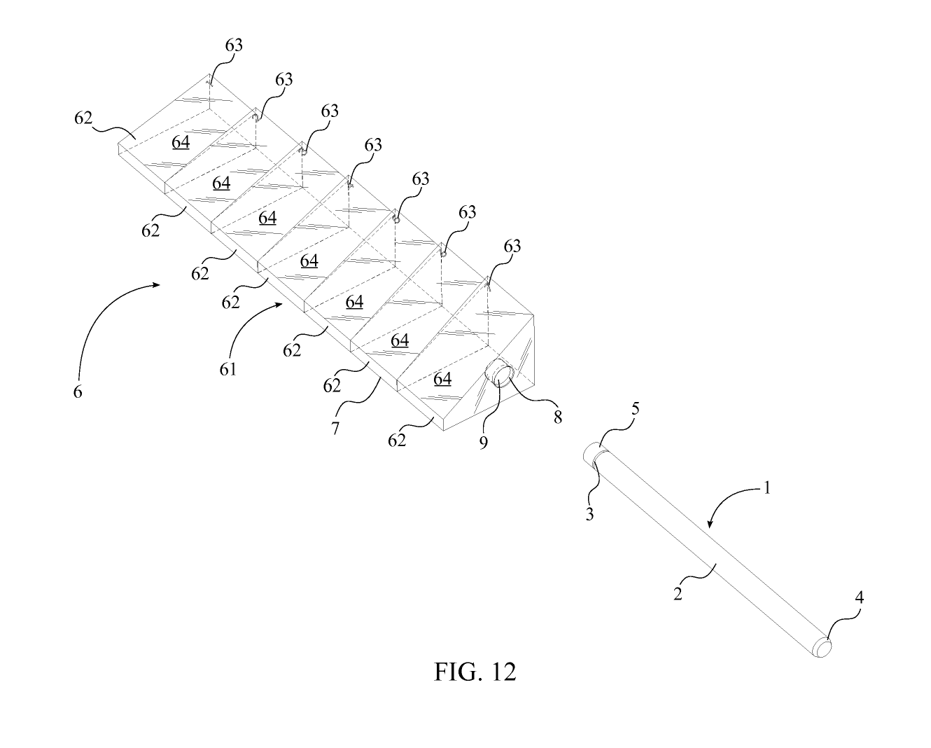

In reference to FIG. 11 and FIG. 12, a sixth alternative embodiment of the present invention, the plurality of devices 6 is a plurality of prism bars 61. Similar to the first alternative embodiment, the plurality of prism bars 61 is normally used in the medical field, where the plurality of prism bars 61 functions as optical exerciser for treating or exercising the muscles of the eye thereby to correct misalignment of the eye that is commonly known as cross eyedness or strabismus. Each of the plurality of prism bars 61 comprises a plurality of prisms 62 that linearly connects to each other within the device body 7, where the plurality of prisms 62 completes the device body 7 of the sixth alternative embodiment. Each of the plurality of prisms 62 comprises a respective diopter identification number 63, where the respective diopter identification number 63 is positioned on each of the plurality of prisms 62. The respective diopter identification number 63 is positioned on a respective prism screening surface 64 of each of the plurality of prisms 62, and all of the respective prism screening surfaces 64 are positioned on the device body 7 and face the practitioner when the sixth alternative embodiment is used by the practitioner. This enhancement makes the plurality of prism bars 61 much better, easier, and quicker for the practitioner so that the practitioner no longer has to move his/her eyes from the respective prism screening surface 64 to the side surface to get the respective diopter identification number 63. The placement of the respective diopter identification number 63 on the respective prism screening surface 64 also results in more accurate readings. Due to the fact there is the possibility of losing its place within the plurality of prisms 62 and recording the incorrect the respective diopter identification number 63, Since the plurality of devices 6 of the sixth alternative embodiment is the plurality of prism bars 61, the chosen device of the sixth alternative embodiment is a single prism bar 61 from the plurality of prism bars 61.

The present invention can also implemented into house hold items and many other items that include, but is not limited to: pots, pans, cups, glasses, dip sticks, wands, umbrellas, masks, bells, faucets, knobs, baskets, canes, chop sticks, flippers, and fixation sticks.

Although the invention has been explained in relation to its preferred embodiment, it is to be understood that many other possible modifications and variations can be made without departing from the spirit and scope of the invention as hereinafter claimed.

What is claimed is:

1. A system of a magnetic attachment handle and attachment devices comprises:
a attachment handle;
a plurality of devices;
the attachment handle comprises a handle body, a first end, a second end, and a handle magnet;
each of the plurality of devices comprises a device body, a cavity, and a device magnet;
the first end and the second end being oppositely positioned from each other along the handle body;
the handle magnet being adjacently connected with the first end;
the handle magnet being concentrically positioned with the handle body;
the cavity traversing into the device body;
the device magnet being concentrically connected within the cavity;
the attachment handle being magnetically attached with a chosen device from the plurality devices through the handle magnet and the device magnet, wherein the chosen device is selected by a user; and
the attachment handle being concentrically positioned with the cavity.

2. The system of a magnetic attachment handle and attachment devices as claimed in claim 1 comprises:
the plurality of devices being a plurality of orthoptics treatment prisms;
each of the plurality of orthoptics treatment prisms comprises a diopter identification number;
the diopter identification number being positioned on the device body; and
the chosen device being one of the plurality of orthoptics treatment prisms.

3. The system of a magnetic attachment handle and attachment devices as claimed in claim 2 comprises:
the diopter identification number being positioned on a prism viewing surface; and
the prism viewing surface being positioned on the device body.

4. The system of a magnetic attachment handle and attachment devices as claimed in claim 1 comprises:
the plurality of attachment devices being a plurality of neutral density bars;
each of the plurality of neutral density bars comprises a plurality of filters;
the plurality of filters being linearly connected to each other;
each of the plurality of filters comprises a respective optical density value;
the respective optical density value being positioned on each of the plurality of filters; and
the chosen device being one of the plurality of neutral density bars.

5. The system of a magnetic attachment handle and attachment devices as claimed in claim 4 comprises:
the respective optical density value being positioned on a density bar viewing surface; and
the density bar viewing surface being positioned on the device body.

6. The system of a magnetic attachment handle and attachment devices as claimed in claim 1 comprises:
the plurality of attachment devices being a plurality of magnifiers;
each of the plurality of magnifiers comprises a respective magnifying number;
the respective magnifying number being positioned on each of the plurality of magnifiers; and
the chosen device being one of the plurality of magnifiers.

7. The system of a magnetic attachment handle and attachment devices as claimed in claim 6 comprises:
the respective magnifying number being positioned on a magnifier viewing surface; and
the magnifier viewing surface being positioned on the device body.

8. The system of a magnetic attachment handle and attachment devices as claimed in claim 1 comprises:
the plurality of attachment devices being a plurality of brush heads; and
the chosen device being one of the plurality of brush heads.

9. The system of a magnetic attachment handle and attachment devices as claimed in claim 1 comprises:
the plurality of attachment devices being a plurality of illumination devices; and
the chosen device being one of the plurality of illumination devices.

10. The system of a magnetic attachment handle and attachment devices as claimed in claim 1 comprises:
the plurality of attachment devices being a plurality of prism bars;
each of the plurality of prism bars comprises a plurality of prisms;
the plurality of prisms being linearly connected to each other;
each of the plurality of prisms comprises a respective diopter identification number;
the respective diopter identification number being positioned on each of the plurality of prisms; and
the chosen device being one of the plurality of prism bars.

11. The system of a magnetic attachment handle and attachment devices as claimed in claim 10 comprises:
the respective diopter identification number being positioned on a respective prism screening surface; and
the respective prism screening surface being positioned on the device body.

12. A system of a magnetic attachment handle and attachment devices comprises:
a attachment handle;
a plurality of devices;
the attachment handle comprises a handle body, a first end, a second end, and a handle magnet;
each of the plurality of devices comprises a device body, a cavity, and a device magnet;
the first end and the second end being oppositely positioned from each other along the handle body;
the handle magnet being adjacently connected with the first end;
the handle magnet being concentrically positioned with the handle body;
the cavity traversing into the device body;
the device magnet being concentrically connected within the cavity;
the attachment handle being magnetically attached with a chosen device from the plurality devices through the handle magnet and the device magnet, wherein the chosen device is selected by a user;
the attachment handle being concentrically positioned with the cavity;
the plurality of devices being a plurality of orthoptics treatment prisms;
each of the plurality of orthoptics treatment prisms comprises a diopter identification number;
the diopter identification number being positioned on the device body; and
the chosen device being one of the plurality of orthoptics treatment prisms.

13. The system of a magnetic attachment handle and attachment devices as claimed in claim 12 comprises:
the diopter identification number being positioned on a prism viewing surface; and
the prism viewing surface being positioned on the device body.

14. A system of a magnetic attachment handle and attachment devices comprises:
a attachment handle;
a plurality of devices;
the attachment handle comprises a handle body, a first end, a second end, and a handle magnet;
each of the plurality of devices comprises a device body, a cavity, and a device magnet;
the first end and the second end being oppositely positioned from each other along the handle body;
the handle magnet being adjacently connected with the first end;
the handle magnet being concentrically positioned with the handle body;
the cavity traversing into the device body;
the device magnet being concentrically connected within the cavity;
the attachment handle being magnetically attached with a chosen device from the plurality devices through the handle magnet and the device magnet, wherein the chosen device is selected by a user;
the attachment handle being concentrically positioned with the cavity;
the plurality of attachment devices being a plurality of prism bars;
each of the plurality of prism bars comprises a plurality of prisms;
the plurality of prisms being linearly connected to each other;
each of the plurality of prisms comprises a respective diopter identification number;
the respective diopter identification number being positioned on each of the plurality of prisms; and
the chosen device being one of the plurality of prism bars.

15. The system of a magnetic attachment handle and attachment devices as claimed in claim 14 comprises:
the respective diopter identification number being positioned on a respective prism screening surface; and
the respective prism screening surface being positioned on the device body.
